(19) United States
(12) Patent Application Publication
(10) Pub. No.: US 2022/0409939 A1
(43) Pub. Date: Dec. 29, 2022

(54) DRY-RISER, DRY RISER SYSTEM, AND ENGINEERING STRUCTURE COMPRISING THE DRY-RISER

(71) Applicant: DANSK BRAND-OG SIKRINGSTEKNISK INSTITUT, Hvidovre (DK)

(72) Inventors: Mikael N. GAM, Roskilde (DK); Asgrimur EIRIKSSON, Valby (DK); Thomas HULIN, Jyllinge (DK); Konrad Wilkens FLECKNOE-BROWN, Tjörnarp (SE); Poul Bjerre TOFTILD, Kolding (DK)

(21) Appl. No.: 17/784,684

(22) PCT Filed: Dec. 18, 2020
(86) PCT No.: PCT/EP2020/087011

§ 371 Date: Jun. 13, 2022

(30) Foreign Application Priority Data
Dec. 20, 2019 (DK) PA 2019 70827

(51) Int. Cl. A62C 35/62; A62C 35/68

(52) U.S. Cl. CPC A62C 35/62; A62C 35/68

(57) ABSTRACT

The present disclosure relates to dry-riser for use in fire fighting, the dry-riser being configured to allow a fluid flow through the dry-riser, wherein the dry-riser comprises at least one inlet and at least one outlet, and wherein the at least one dry-riser outlet comprises a quick-release valve coupling for connecting the at least one dry-riser outlet to a fire hose. The disclosure further relates to a dry-riser system comprising the dry-riser and a fire hose, and an engineering structure comprising the dry-riser.

by pumps intersecting the water supply line to provide a sufficiently high water pressure to upper floors or upper locations in the engineering structure.

In case of fire, however, there is a risk that such a system, based on the permanent supply water line, fails e.g. due to power outages, pipe corrosion, or the like. Furthermore, firefighters or similar trained personnel will typically need to enter rooms where sprinkler systems have been activated to res-cue any potential persons in the room. Hence, as also described with respect to the other mentioned automated fire systems, sprinkler systems similarly do not remove the need for firefighting activities to be performed by skilled fire-fighters in case of fire but merely slows down the spreading of the fire.

Alternative automated fire suppression systems are for example gas extinguishing systems, carbon dioxide, or otherwise chemically based fire suppression systems, which are often used in critical areas where fires may spread rapidly or cause severe damage to buildings or business, such as storage rooms with hazardous materials, server rooms or industry kitchens. These systems can be used to slow down or prevent a fire from escalating and/or spreading until firefighters arrive to extinguish the fire. Such systems are, nonetheless, financially expensive to install, have a risk of failure or malfunction, and furthermore require regular testing and maintenance, and are therefore rarely used throughout all parts, rooms, or the like of the engineering structure. Even where automated fire suppression systems are installed, they may, thus, not remove the need of firefighters.

To provide water for firefighting activities, dry-risers are often integrated in modern-day engineering structures to allow transport of water inside the engineering structure for use in the firefighting activities by the skilled fire-fighters. The dry-risers remain without water, until firefighters or similar trained personnel connects their own water supply and pumps thereto to ensure a stable water supply. Such dry-risers consist of a dedicated large diameter water pipe with outlets, typically each comprising valves, at various places in the engineering structures, such as on different stories of a building, and an inlet for connecting the water supply, typically arranged on a level vertically below the outlets, such as on street-level or the like to provide easy access for the fire service. The outlets, inlets and water pipe typically have dimensions corresponding to those of standard fire hoses and are assembled with the fire hoses in the same way. To provide a stable water supply during a fire as well as to provide the fire fighters with control over the system, the water to the dry-riser is typically provided from the pump of a fire truck, a fire hydrant, or from an external pump connected to a water supply to the inlet.

Time is a critical parameter when a fire breaks out, and efforts are typically made to allow the fire fighters to start rescuing people, extinguish and/or control the fire as soon as possible after their arrival at the engineering construction on fire. Fire hoses are usually stored on fire engines to allow the fire fighters to start extinguishing and/or controlling the fire. The fire hoses used with such systems are normally standard fire hoses which can be interconnected by means of a commonly used coupling, such as a Storz-coupling, to obtain a desired fire hose length. Similarly, such well-known couplings are typically used to interconnect the fire hose and the dry-riser outlet as well as a water supply hose to the dry-riser inlet. To use the dry-riser, a firefighter or other trained personnel typically connects a fire hose to an outlet near the fire and open a valve at the outlet. When water is applied to the dry-riser via the inlet, e.g. from a fire truck or fire hydrant, water will flow through the open valve and through the hose, through the dry riser and then through the outlet and then a fire hose.

However, since the dry-riser is dry until the firefighters connect the water supply thereto, it will not show whether an outlet valve has been opened or not, until water is supplied. Thus, when a fire breaks out and water is needed from an outlet, all valves upstream, i.e. nearer the water supply, need to be closed to provide a sufficient water pressure at the outlet. It may therefore remain a problem to maintain a sufficient water pressure throughout the dry-riser, and notably at the outlets which are the furthest away from the inlet.

It is moreover a general object in the field to reduce the setup time, i.e. time from the firefighters arrive at the location of the engineering structure until the firefighting commences.

Furthermore, such dry-risers typically take up valuable space in the constructions due to the outlet dimensions of the dry-riser. The commonly used fire hoses for these systems remain compressed until filled with water, at which point they expand from a substantially flat shape to having a substantially circular cross-section. They must therefore be laid out on the ground before they are connected to the water supply and filled with water, which, again, takes up space, takes time, and provides a low degree of flexibility for the firefighters.

### SUMMARY

It is therefore an object of the present disclosure to provide a dry-riser system which allows for sufficient pressure along the outlets as well as reduces the necessary setup time. Furthermore, an object of the present disclosure is to reduce the required space inside the engineering construction for the dry-riser system.

It has now been found that this problem may be solved by providing a novel dry-riser for use in firefighting, the dry-riser being configured to allow a fluid flow through the dry-riser, wherein the dry-riser comprises an inlet and at least one outlet, and wherein the at least one dry-riser outlet comprises a quick-release valve coupling for connecting the at least one dry-riser outlet to a fire hose.

The fluid may be a liquid, such as water or water mixed with foam concentrate. Alternatively, the fluid may be water or a gas, such as carbon dioxide, nitrogen, or the like. The dry-riser may be configured to transport fluids from the inlet to the one or more outlets. In some examples, the dry-riser is configured to transport a liquid. The liquid may be water. Throughout this text, the fluid in the dry-riser may exemplarily be described as water. It will, however, be appreciated that the fluid may be another fluid than water and that the water flow may be a flow of another fluid than water.

Throughout this application, downstream may be understood as further from the water supply when seen in pipe length and/or in a flow direction of the water flow, and upstream may be understood as closer, in pipe length and/or in the flow direction, to the water supply.

By firefighting is here to be understood activities carried out by trained personnel, such as professional and/or voluntary firefighters, to limit, reduce, and/or extinguish a fire or the spreading thereof. Automated systems, such as suppression system, acting in response to signs of fire, heat, and/or an alarm going off is, however, not to be construed as firefighting in the meaning of the present text.

By the at least one dry-riser outlet comprising a quick-release valve coupling for connecting the at least one dry-riser outlet to a fire hose, a simpler interconnection, in use, between a fire hose and the at least one dry-riser outlet may be provided. This may reduce the time necessary for the fire-fighters to connect the hose to the dry-riser, and thereby the total needed time from the firefighters arrive at the relevant position until the firefighting can be initiated.

An engineering structure may comprise buildings, such as housing, hotels, office buildings, or parking garages, offshore constructions, such as oil drilling platforms, or ships, such as container ships, vessels, cruise ships, or ferries. Various other constructions where firefighting must be taken into consideration during construction may, however, also be considered an engineering structure in this specification.

The term “manual valve” or “manually operated valve” are used inter-changeably throughout this specification. The terms here describe a valve comprising means for manual opening/closing of the valve. The means may comprise a handle for opening and closing the valve. The manually operated valve may be a ball valve.

Fire hose(s) may be connected to the at least one dry-riser outlets, either before or after a water supply is connected to the inlet, i.e. with or without water pressure in the dry-riser. Thus, water can be connected to the inlet at the most time-efficient point in time, i.e. before or after a firefighter has approached the outlet and attached a hose thereto. This, in turn, allows for a reduced setup time and, thus, a reduced time from fire detection until firefighting activities can commence.

Where the dry-riser comprises a plurality of dry-riser outlets, each of the dry-riser outlets may be provided with a quick-release valve coupling. The outlet quick-release coupling, in turn, may allow for a reduced setup time from arrival till the firefighting commences. When a fire, for instance, breaks out on a sixth floor of a building having an existing, commonly known dry-riser with an outlet on each floor, the firefighter must manually pass by all outlets upstream of the sixth floor outlet to ensure that the valves of these outlets are manually closed before opening the sixth floor outlet, or even before the water supply is connected. The firefighter having to go by and checking these five outlets on the first to fifth floor upstream of the outlet on the sixth floor may lead to a critical increase in critical time before the firefighting can commence. The outlet quick-release valve coupling of the dry-riser according to the present disclosure, however, may remove the need for a firefighter to do so, by preventing a flow through the outlet when no fire hose is connected to the outlet, thereby reducing the setup time. In some examples, the outlet quick-release valve coupling may be opened, i.e. allow a flow there through, only when a fire hose is connected at the outlet. Consequently, the outlet quick-release valve coupling may be and/or comprise a normally closed type of valve coupling.

Moreover, the quick-release valve coupling of the outlet, where a plurality of outlets is provided, may further ensure a sufficient water pressure at the desired outlet to be used for firefighting by hindering a water outflow upstream of the desired outlet.

The inlet of the dry-riser may be configured to be connected to water supply, preferably a high pressure water supply. The high pressure water supply may be capable of providing at least an operating water pressure inside the dry-riser. The high pressure water supply may be a water supply from a fire pump, e.g. placed on a fire truck, or the like, preferably separate from and provided separately from any permanent water supply, such as drinking or sanitation water supply, of the engineering construction. Thereby, a water flow, sufficient for firefighting, may be provided even in case of failure of the permanent water supply. Furthermore, such a high pressure water supply allows firefighters or similar trained personnel to control the water pressure and when water is supplied in the dry-riser and when not. This, in turn, allows e.g. connection of fire hose(s) to the at least one outlet when there is no water pressure inside the dry-riser, making the connection between fire hoses and outlets easier and faster.

In some examples, the quick-release valve coupling may further be used to interconnect sections of fire hose where a longer fire hose is needed, in turn allowing for a quick and easy interconnection of fire hose sections.

The quick-release valve coupling may comprise a valve coupling, which is adapted to receive and/or connect to an end of a fire hose. The quick-release valve coupling may alternative and/or additionally be configured to retain and/or secure the fire hose end. The fire hose may comprise a valve engaging part adapted to interact with the quick-release valve coupling. The quick-release valve coupling may be in a closed state when no fire hose end is retained at the quick-release valve coupling and may be in an open state when a fire hose end is retained therein. The retaining of the fire hose end may be carried out by means of snap acting engaging means. The quick-release valve coupling may be configured to allow the retaining of the fire hose to be engaged/disengaged by hand, i.e. not requiring a tool, potentially using one hand only. The fire hose may be received at and/or connected to the quick-release valve coupling at a first end thereof. The first end of the quick-release valve coupling may be arranged oppositely to a second end of the quick-release valve coupling, the second end potentially being connected to a pipe of the dry-riser.

The quick-release valve coupling may be configured to be in an open state, such as a state allow a fluid flow through the quick-release valve coupling, when a hose is connected thereto, potentially only when the hose is connected thereto. Alternatively or additionally, the quick-release valve coupling may be configured to be in a closed state, such as a state preventing a fluid flow through the quick-release valve coupling, when the hose is not connected to and/or disconnected from the quick-release valve coupling.

In some examples, the quick-release valve coupling comprises a first valve portion and a second valve portion. The first valve portion may be a first valve and/or the second valve portion may be a second valve. The first valve portion may be a manually-operated valve, such as a ball valve, potentially configured to be opened and closed by hand by an operator. The first valve portion may be operable regardless of whether or not a hose is connected to the quick-release valve coupling.

The second valve portion may be a valve, which is configured to prevent a flow of fluid through the valve until activated. The second valve portion may be configured to be activated by engaging a part, e.g. a male or female part of a coupling portion, of a hose with a part of the second valve portion, e.g. a female or male part, respectively, of the second valve portion. In some examples, the second valve portion is a check valve, a non-return valve, and/or a one-way valve. Alternatively or additionally, the second valve portion may comprise a quick-release element configured to provide a quick-release coupling with the hose and/or the part of the hose.

The second valve portion of an outlet quick-release valve coupling may be arranged downstream of the first valve portion.

Thereby, a user may be allowed to manually close the first valve portion to prevent a water pressure at the second valve portion, in turn allowing for an easier coupling, as insertion of the insert portion into the coupling body may be easier.

Additionally or alternatively, the quick-release valve coupling may comprise a coupling body configured to receive an insert portion. The insert portion may be an insert portion of a coupling portion of a fire hose, potentially a fire hose to be connected to the quick-release valve coupling. The coupling body may be considered and/or may be a female element and the insert may be considered and/or may be a male element. Alternatively or additionally or an insert portion configured to receive a coupling body, the coupling body potentially being a coupling body of a coupling portion of a fire hose.

The quick-release valve coupling may be configured to allow an insertion of the insert portion into the coupling body in a single movement. This may allow for an easier coupling, as a user may perform the coupling by inserting the insert portion into the coupling body using one hand.

The quick-release valve coupling may be configured to provide a fluid-tight, such as a water-tight, seal when coupled to the hose. For instance, the fluid-tight seal may be provided, when an insert portion of a hose is inserted into and/or engaged with the coupling body of the quick-release valve coupling. The quick-release valve coupling may comprise a seal, a gasket, and/or an O-ring arranged to provide the fluid-tight and/or water-tight seal.

Additionally or alternatively, the quick-release valve coupling may comprise a quick-release element, such as a, potentially spring-loaded, locking ring and/or a locking button, configured to lock an engagement of a hose with the quick-release valve coupling and/or to allow a user to disengage the hose from the quick-release valve coupling. The user may disengage the hose by sliding the locking ring and/or pushing the locking button, respectively.

The quick-release valve coupling may have a maximum outer cross-sectional extent, such as an outer diameter, which corresponds to an outer diameter of the dry-riser and/or of the fire hose. The maximum outer cross-sectional extent of the quick-release valve coupling may be equal to the outer diameter of the dry-riser and/or the fire hose. The quick-release valve coupling may comprise an actuation part such as a handle. An extent or outer dimension of a potential actuation part of the quick-release valve coupling is not included in the maximum outer cross-sectional extent of the quick-release valve coupling.

The at least one fire hose may be a dimensionally stable fire hose, such that an aperture of the fire hose(s) has substantially the same cross-section regardless of whether there is a fluid, such as water, in it or not. The at least one fire hose may be flexible. The dimensionally stable fire hose may be made from a rubber material as further described below.

The dry-riser and/or at least a portion thereof may, e.g. where this is provided in a building, extend in a height direction substantially parallel to a vertical direction. The inlet and the at least one outlet may be arranged at different positions in the height direction. The inlet may be arranged below some or all of the outlets.

Alternatively, in some engineering structures, such as container ships, parking garages, vessels, oil platforms, or the like, the dry-riser may extend in length direction substantially parallel to a horizontal direction.

The dry-riser may comprise a pipe or a tube, such as a metal pipe made from one or more of steel, a steel alloy, such as a stainless steel alloy, copper, a plastic material, such as polyvinylchloride (PVC), a polymer, carbon steel, cupronickel, tantalum, tempered glass, Teflon-based materials, compo-site materials, potentially comprising carbon fibre, or any combination thereof.

The dry-riser may further comprise a discharge outlet, potentially comprising a valve, such as a manual valve, for emptying water from the dry-riser. Alternatively, or additionally, the dry-riser may comprise an air inlet for pressurised air. The potential air inlet may allow a user, such as a firefighter, to let in air, such as pressured air, into the system. The air inlet may comprise a valve to prevent water from flowing out of the air inlet, such that a water pressure may be maintained inside the dry-riser. Where the air inlet is provided in combination with the emptying outlet, air supplied to the dry-riser through the air inlet may assist in a quick and/or complete emptying of water from the dry-riser through the emptying outlet. The air inlet may be arranged upstream, i.e. closer in pipe length to the inlet, than a discharge outlet. The air inlet may for instance be arranged above or below a discharge outlet in the height direction where the dry-riser extends in the height direction.

The dry-riser inlet may be configured to be connected to a high pressure water supply, such as a high pressure water supply of a fire pump potentially arranged on a fire truck. The dry-riser may comprise additional inlets. The dry riser may, notably where the dry-riser extends in a height direction, alternatively or additionally comprise pressure relieving sections for the water supply. The pressure relieving sections may be sections extending at an angle, such as a 30-degree angle, to the height direction and/or to a length direction of the dry-riser.

Alternatively or additionally, the dry-riser may comprise one or more of a venting port to allow potential air in the dry-riser to exit the dry-riser, when a water supply is connected thereto. That is, the venting port may comprise a valve arrangement, such as an excess pressure valve, configured to allow air to flow out of the dry-riser when the pressure inside the dry-riser increases above a predetermined threshold. Thereby, a high water pressure may be maintained inside the dry-riser and a steady water supply be provided at the outlets.

Alternatively or additionally, the dry-riser may comprise an emptying outlet for emptying water from the dry-riser, such as after use of the dry-riser. Thereby, the dry-riser may be left dry and ready for a subsequent use, in turn reducing the wear on and risk of corrosion in the dry-riser. The emptying outlet may be arranged such that all or substantially all the water inside the dry-riser may run towards the emptying outlet, e.g. at a lower or lowermost point in a vertical direction. The emptying outlet may comprise a valve, such as a manually operated valve, which can be opened and/or closed to empty potential water from the dry-riser or maintain water and/or a water pressure inside the dry-riser, respectively.

The dry-riser and/or at least a portion of the dry-riser may be configured to have a high pressure operating water pressure of at least 20 bar, preferably in the range of 20 bar-150 bar, preferably in the range of 25 bar-120 bar, preferably in the range of 30 bar-80 bar.

Thereby, a sufficiently high water pressure to ensure that a water flow sufficient to extinguish a fire, at outlets far from and/or raised, in a vertical direction, above the dry-riser inlets may be provided. Notably, when the dry-riser is installed in a tall engineering structure, a sufficient water flow may need to be provided several decametres, i.e. tens of metres, above the inlets of the dry-riser. The sufficient water flow may be sufficient to supply water to a sufficient number of fire hoses. For example, the sufficient water flow may be up to 200 litres/min (l/m) per outlet connected to a fire hose or more. The water flow may be at an outlet of the dry-riser.

The dry-riser and the inlets and outlets thereof may be configured to have the desired operating water pressure inside the dry-riser. The dry-riser inlets, outlets, and/or potential further elements of the dry-riser may thus be able to withstand at least the desired operating water pressure. Alternatively or additionally, the dry-riser inlets, outlets, and/or potential further elements thereof may be configured to withstand pressures above the desired operating pressures, such as at least 10%, 15%, 20%, 25%, 30%, or 40% above the desired operating pressure. The pressure inside the dry-riser may vary at various locations, such as at various positions in a vertical direction due to gravitational force acting on the water inside the dry-riser.

A water pressure of at least 20 bar, such as in the range from 20-150 bar may be provided at the inlet. Alternatively, or additionally, a pressure of at least 8 bar, such as at least 10 bar, at least 12 bar, at least 14 bar, or more may be provided at an outlet, potentially at each outlet.

The dry-riser inlet may comprise a second quick-release valve coupling for connecting the dry-riser inlet to a water supply.

This, in turn, allows for a reduced connection time, as the water supply, such as a water pump of a fire truck, may be easily connected to the dry-riser.

The second quick release valve coupling may correspond to and/or be similar to the quick-release valve coupling of the at least one outlet. This may allow for an interchangeability between fire hoses, such that the same fire hose section, potentially including a quick-release valve engaging part for connecting to the outlet quick-release valve coupling or the second quick-release valve coupling, may be used to extend a water supply hose length at the inlet as well as a fire hose length at an outlet of the dry-riser.

The second quick release valve coupling may be configured to receive and/or retain a water supply hose of the water supply, such as of the fire truck. The water supply is preferably a high pressure water supply capable of delivering a sufficient water flow to establish the operating water pressure in the dry-riser. Preferably, the water supply is a high pressure water pump of a fire truck connected to the inlet by means of a high pressure supply hose, such as a hose made from a rubber material. The supply hose may be made from a rubber material or the like and may be configured to have an operating pressure similar to that of the dry-riser.

The second quick-release valve coupling may comprise a check valve, preferably arranged upstream of a manually operated valve of the second quick-release valve coupling.

By the second quick-release valve coupling comprising a check valve and a manually operated valve, an easier connection of the water supply to the inlet may be provided, as the manually operated valve may be closed to remove a potential excess pressure at the inlet. The potential excess pressure may origin from water in a pipe of the dry-riser and/or from the water supply. The manually operated valve may be a ball valve comprising a handle part to be manually operated e.g. by a firefighter.

The quick-release valve coupling of the at least one outlet may comprise a check valve.

The quick-release valve coupling comprising a check valve may further aid in assuring that a water flow is only provided when a fire hose is connected to the outlet quick-release valve coupling. In some examples, the check valve may further comprise retaining means for retaining a valve engaging part of the fire hose, where this is provided. Moreover, notably, where the dry-riser comprises several outlets, the check valve may aid in ensuring a sufficiently high water pressure to allow for a for fire extinguishing sufficient water flow at all potential outlets of the dry-riser, as the check valve may prevent water from exiting outlets, to which a fire hose is not connected.

The quick-release valve coupling may be configured to connect to and/or retain the fire hose. In some examples, the check valve may be comprised in a fire hose receiving portion of the outlet. Upon connection of the fire hose to the outlet, the check valve may be actuated and/or opened to allow a water flow through the fire hose. The actuation and/or opening of the valve may be provided by the fire hose comprising a connecting portion with an actuating element, such as a tapered portion, actuating and/or opening the check valve, such as mechanically pushing back a flow limiting element of the check valve.

The quick-release valve coupling further may comprise a manually operated valve, preferably a ball valve.

This allows for an easier and less time-consuming connection of the hose, as the fire hose may be connected to the dry-riser when a water supply is connected to the inlet of the dry-riser and a water pressure exists within the dry-riser, since a water flow and hence water pressure at the outlet may be closed off by the manually operated valve. The manually operated valve may comprise a handle part to be turned to open and/or close the ball valve.

The check valve of the quick-release valve coupling may be arranged downstream of the manually operated valve.

Consequently, the water pressure may be reduced from the check valve whilst the fire hose is being connected to and/or disconnected from the quick-release valve coupling by means of the manually operated valve. This, in turn, may reduce the required setup time as hoses may be connected/disconnected whilst a there is a water pressure in the dry-riser as well as at the outlets.

An inner diameter of the dry-riser may be less than 50 mm, preferably less than 40 mm, preferably less than or equal to 35 mm.

The inner diameter may be the diameter of the aperture of the dry-riser.

Hence, the outer dimensions of the dry-riser may be smaller than the commonly known dry-risers, typically having an inner diameter of at least 75-80 mm. This may provide a smaller system than the commonly known dry-risers may be provided, in turn allowing for less space consumption inside the engineering structure. Additionally, when the dry-riser has a high pressure operating water pressure, the pressure in and water flow through the present smaller diameter dry-riser may be set to be sufficient for fire extinguishing and/or firefighting equipment, such as jet nozzles or the like.

Moreover, fire hoses with smaller diameters, again taking up less space inside the engineering structures, in which the dry-riser is installed and hoses are stored nearby the dry-riser outlets, may be used. Where hoses are brought from e.g. a fire truck or the like, the hoses with smaller diameters may be easier to carry, fill with water, as well as easier in use for the firefighter as they may not need to be rolled out before they are filled with water. Correspondingly, the interconnection of hoses and/or the quick-release valve coupling may be provided to correspond to the inner diameter of the dry-riser and/or the hoses. The quick-release valve coupling may, thus, have an inner diameter substantially equal to or equal to the dry-riser having the inner diameter of less than 50 mm, less than 40 mm, or less than or equal to 35 mm.

Where the quick-release valve couplings are used to interconnect hose sections, a smaller maximum outer cross-sectional extent, such as a maximum outer diameter, than a traditional coupling, i.e. a Storz coupling, may be allowed for, as a maximum outer cross-sectional extent of the quick-release valve coupling may substantially correspond to that of the fire hose and/or fire hose section. This, in turn, allows for an easier maneuvering of the fire hose, notably around corners and/or doors.

The inner as well as outer diameter of the dry-riser may correspond to that of a traditional water pipe, such as a 25.4 mm (1 inch) water pipe, a 19.1 mm (¾ inch) water pipe, or the like. Depending on the necessary outlet water pressure and due to the water pressure inside the dry-riser, in use, a traditional water pipe with traditional fittings, joints, and the like, may in some examples not be suitable as dry-riser. However, high pressure capable pipes, fittings, and joints are well-known and will, thus, not be described in further detail throughout this specification.

In some examples, the inner diameter may be larger, such as up to 80 mm, up to 100 mm, or larger at the inlet to allow for a larger water flow. The inner diameter of or near the outlets may be less than 50 mm.

The pressure in use of the dry-riser having an inner diameter in the range below 50 mm, below 40 mm, and/or equal to or below 35 mm may be higher than in traditional dry-risers, such as the operating water pressure as described above.

A second aspect of the present disclosure relates to a dry-riser system for use in firefighting, the system comprising: a dry-riser according to the first aspect of the disclosure, and at least one fire hose.

The dry-riser system according to the second aspect may show similar advantages and/or be implemented similar to the dry-riser according to the first aspect.

The system may further comprise a pressure increasing component configured to increase the pressure in the dry-riser. This may be particularly advantageous in elevated engineering constructions with outlets arranged well above ground level, such as multi-story buildings, where gravity will cause a high water pressure difference along the dry-riser. The pressure increasing component may be connected to the dry-riser. The pressure increasing components may be arranged at and/or connected to the dry-riser at a level above the outlet.

The at least one fire hose may comprise a quick-release coupling part configured to be connected to the quick-release valve coupling so as to allow a water flow from the dry-riser to the fire hose, when the quick-release valve coupling is in a connected state.

The at least one fire hose may be a dimensionally stable fire hose, such as a rubber hose. By dimensionally stable is here to be understood that the fire hose may have an aperture having a predetermined diameter regardless of whether or not there is water in the fire hose. Hence, the fire hose may, contrary to traditional fire hoses, be used without being entirely rolled and/or laid out before water is applied. By using dimensionally stable fire hoses the quick release couplings the hoses may take up less space and may be faster and easier to operate for the firefighters. This allows for more flexibility during firefighting and reduces the time from the firefighters arrive at the engineering construction until the fire-fighting can commence.

The quick-release coupling part may be a valve actuation part, potentially configured to activate the check valve of the quick-release valve coupling. In some examples, the quick-release coupling part of the fire hose may comprise a cone-shaped element, which, upon connection to the quick-release coupling, interacts with an element of the check valve so as to open this.

Thereby, the quick-release valve coupling may be opened, i.e. allow a flow of water through the quick-release valve coupling to the fire hose, upon insertion of the fire hose. This, in turn, allows for an easy and time-efficient connection of the fire hose to the outlet. The quick-release valve coupling may comprise a manually operated valve, such as a ball valve, and a check valve arranged downstream of the manually operated valve.

An inner diameter of the at least one fire hose may be less than 40 mm, preferably less than 35 mm, preferably less than or equal to 30 mm.

Thereby, a higher pressure inside the fire hose compared to the traditional fire hoses, which are not dimensionally stable, having inner diameters of e.g. around 50 mm, 75 mm, or 102 mm may be provided. The at least one fire hose may be configured to have an operating pressure, i.e. a pressure in use, of above 15 bar, such as above 18 bar, above 21 bar, above 25 bar, above 30 bar, or more. Alternatively or additionally, the at least one fire hose may be adapted to have an operating pressure in the range from 15 bar up to 50 bar, 20-50 bar, 25-45 bar, or the like. The fire hose may be made from a material having sufficient material strength to withstand pressures in these ranges. The at least one fire hose may be adapted to allow a water flow of more than 200 litres per minute (l/m), such as 300 l/m, 400 l/m, 450 l/m, or 500 l/m. The water flow may be measured as a water flow through a cross-section of the at least one fire hose. A diameter of the cross-section may correspond to the inner diameter of the at least one fire hose.

In some examples, the at least one fire hose is dimensionally stable.

The fire hose may be dimensionally stable as described with respect to the first aspect of the disclosure. By dimensionally stable may here be understood that an aperture and/or inner diameter of the fire hose remains the same regardless of whether it is filled with water or not. The material may be flexible. Examples of such a material is rubber materials, such as EDPM rubber, nitrile rubber materials, a polymer, such as polyvinylchloride (PVC), or any combination thereof. The fire hose may further be provided with a layer of nylon and/or polyester on an inner side, facing an inside diameter of the at least one fire hose, and/or on an outer side, facing the exterior.

A third aspect of the present disclosure relates to an engineering structure comprising a dry-riser according to the first aspect.

The engineering structure comprising the dry-riser may yield the same advantages as the dry-riser according to the first aspect of the disclosure and/or as the dry-riser system according to the second aspect of the disclosure. Similarly, examples described with respect to the dry-riser and/or to the dry-riser system may similarly apply to the engineering structure according to the third aspect of the disclosure.

The different aspects of the present disclosure can be implemented in different ways including as a dry-riser for use in firefighting, a dry-riser system, and an engineering structure comprising the dry-riser as described above and in the following, each yielding one or more benefits and advantages described in connection with at least one of the aspects described above, and each having one or more preferred examples corresponding to the preferred examples described in connection with at least one of the aspects described above.

Furthermore, it will be appreciated that examples described in connection with one of the aspects described herein may equally be applied to the other aspects.

### BRIEF DESCRIPTION OF THE DRAWINGS

The dry-riser, the dry-riser system, and the engineering construction comprising the dry-riser system will now be described in greater detail based on non-limiting exemplary examples and with reference to the drawings, on which:

FIG. 1 shows a schematic view of an embodiment of a dry-riser system according to the present disclosure installed in a building,

FIG. 2 shows a schematic view of a water flow in the embodiment of the dry-riser system shown in FIG. 1,

FIG. 3 shows a perspective view of another embodiment of the dry-riser system according to the present disclosure,

FIG. 4 shows a perspective side view of an outlet of the dry-riser system shown in FIG. 3,

FIG. 5a shows a perspective view of an inlet of the dry-riser system shown in FIG. 3, and

FIG. 5b shows a perspective top view of the inlet shown in FIG. 5a.

Similar reference numerals are used for similar elements across the various examples and figures described herein.

### DETAILED DESCRIPTION

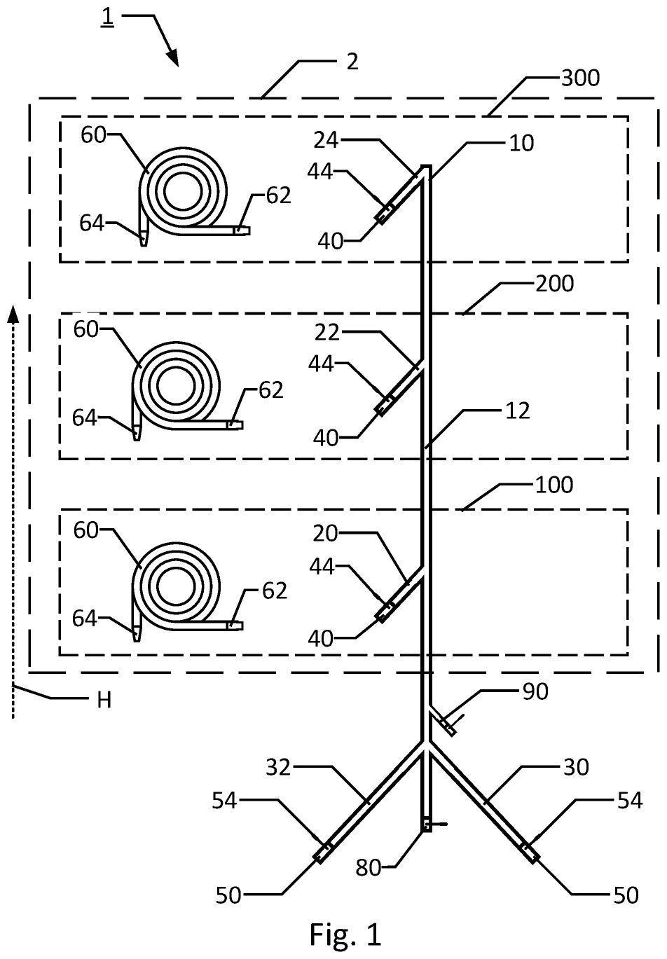

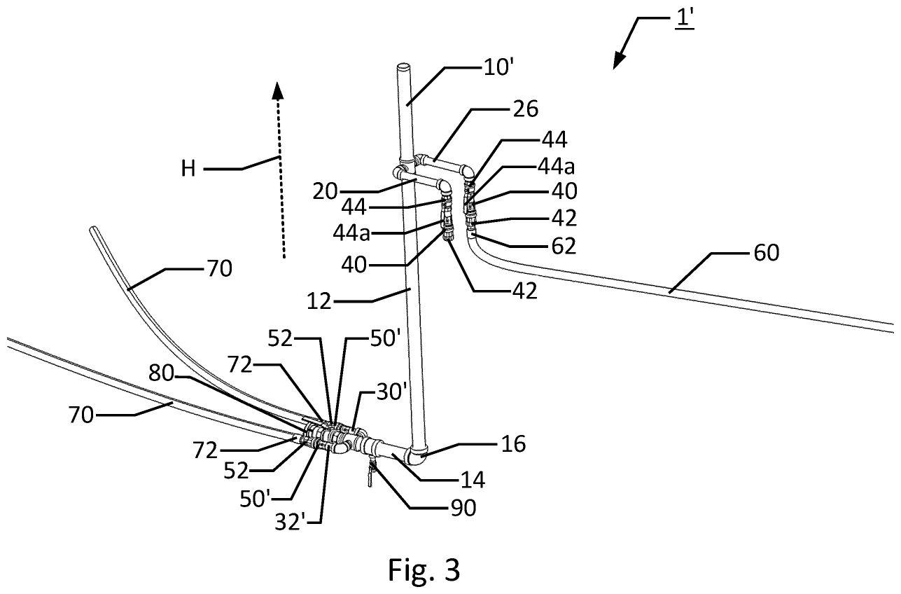

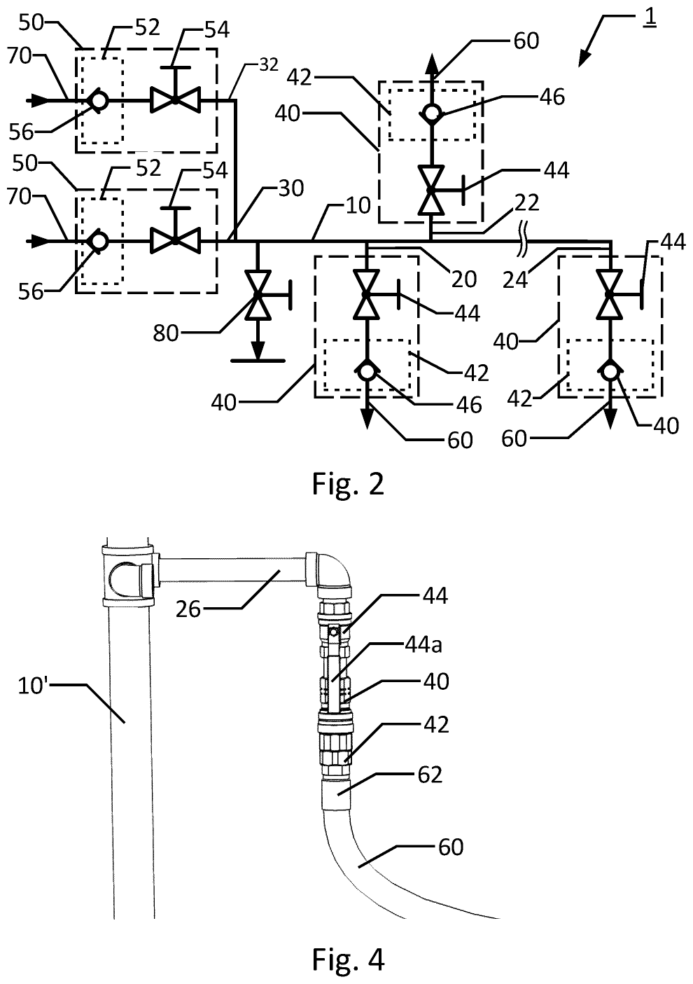

In FIG. 1, a schematic view of an embodiment of a dry-riser system 1 according to the present disclosure is shown, when installed in a building 2 comprising multiple storeys 100, 200, 300. The dry-riser system 1 comprises a dry-riser 10 having a first section 12 extending through the multiple storeys 100, 200, 300 of the building 2 in a substantially vertical height direction H, and a first 20, a second 22, and a third outlet 24 as well as a first 30 and second inlet 32. FIG. 2 shows a functional flow chart of the dry-riser system 10 illustrated in FIG. 1.

The dry-riser first section 12 is a pipe having a substantially circular cross-section and made from a stainless steel alloy and having an internal aperture with a diameter of 30 mm. In other examples, the dry-riser first section 12 may be made from and/or comprise a different material, such as copper, carbon steel, steel, cupronickel, tantalum, tempered glass, Teflon-based materials, or any combination thereof.

The dry-riser first section 12 is configured by means of the material and material dimensions to have an operating water pressure inside the aperture of the dry-riser first section 12 of up to 70 bars. The dry-riser first section 12 has a substantially same aperture diameter as well as a same outer diameter along an entire length thereof. However, as the water pressure as well as the needed water flow, in use, may vary along the dry-riser first section 12, the dry-riser first section 12 may in other examples vary in an internal aperture diameter or an outer diameter. In some examples, an internal aperture diameter and/or an outer diameter of the dry-riser first section 12 may be larger at a lower point in the vertical height direction H of the dry-riser and smaller at a higher point in the vertical height direction H to be operable at the desired water pressure. Where the dry-riser system 1 is provided in a different engineering structure, such as a container ship, the dry-riser first section 12 may extend in a substantially horizontal direction. The aperture diameter and/or the outer diameter of the dry-riser first section may in this case be substantially the same along the entire length of the dry-riser first section 12 or may vary.

The dry-riser 10 further comprises the first 20, the second 22, and the third outlet 24 respectively arranged on a first 100, second 200 and third storey 300 of the building 2. Each of the first 20, second 22, and third outlets 24 are illustrated extending at an angle of approximately 40 degrees to a longitudinal axis of the dry-riser first section 12. They may however be extending at a different angle to the dry riser first section 12, such as substantially in parallel or substantially orthogonally thereto. The first 20, second 22 and third outlets 24 are made from the same material as the dry-riser first section 12. The outlets 20, 22, 24 are mounted such that an aperture of each of the outlets are fluidly connected to the aperture of the first section 12. The outlets 20, 22, 24 are mounted on the first section 12 by means of pipe fittings, such that an aperture of a respective aperture of the outlets 20, 22, 24 faces the fitting and via this is connected to the aperture by means of a respective opening in the first section 12. In other examples, the outlets may be integrally formed with the first section 12 and/or connected thereto by other means, such as by means of internal threads in the outlets 20, 22, 24 and in a respective opening in the first section 12.

Each of the outlets 20, 22, 24 further comprise a quick-release valve coupling 40, comprising a manually operated ball valve 44 as well as a fire hose receiving portion 42 comprising a check valve 46. The manually operated ball valve 44 is arranged upstream of, i.e. nearer along a flow path the dry-riser first section 12 and/or the first or second inlet 30, 32 than the fire hose receiving portion 42 and check valve 46, as also shown in FIG. 2. Thereby the manually operated ball valve 44 may be closed to prevent a water flow and thus a water pressure at the fire hose receiving portion 42, which is useful e.g. when a fire hose 60 is connected to the fire hose receiving portion 42. The manually operated ball valve 44 may be any known manually operated ball valve able to operate at the desired operating pressure. In other examples, the manually operated ball valve 44 may be a different type of manually operated valve, such as a manually operated butterfly valve, a manually operated globe valve, a manually operated gate valve, and/or a manually operated diaphragm valve.

The dry-riser 10 including the first section 12, outlets 20, 22, 24, and inlets 30, 32 thereof are configured to have an operating water pressure inside the respective apertures thereof of 70 bar. The dry-riser 10 is, however, able to withstand higher water pressures up to 90 bar without breaking. The operating water pressure, however, ensures a sufficient water flow for the system to be efficient in firefighting, i.e. approximately 200 I/m.

The fire hose receiving portion 42 is configured to receive a fire hose 60 and fluidly connecting this to the check valve 46 and, when this is opened, to the manually operated ball valve 44 and, when this is opened, further to the dry-riser first section 12 and thereby to the inlets 30, 32. The fire hose receiving portion 42 has spring-loaded snap-acting means (not shown), which are configured to receive a connecting portion 62 of the fire hose 60, to provide the quick-release functionality. The snap-acting means are configured to engage with grooves on an outer side, i.e. on the side facing away from an aperture of the fire hose 60, of the fire hose connecting portion 62, such that, when the connecting portion 62 of the fire hose 60 is inserted into the fire hose receiving portion 42, it retains the connecting portion 62. The connecting portion 62 of the fire hose 60 can further be quickly disconnected from the fire hose receiving portion 42 by pulling an outer peripheral ring member (not shown), i.e. a locking ring, of the fire hose receiving portion 42 in a direction away from the respective outlet 20, 22, 24, whereby the spring causes the snap-acting means to disengage the groove of the connecting portion 62. Alternatively or additionally, different engagements may be provided between the connecting portion 62 of the fire hose 60 and the fire hose receiving portion 42, such as engagement of connecting means in an inner groove, spring-loaded barbs, or any combination thereof. In other examples, the fire hose receiving portion 42 may additionally or alternatively comprise any other known type of snap-acting means.

When the connecting portion 62 of the fire hose 60 is inserted into the fire hose receiving portion 42 of the quick-release valve coupling 40 and engaged with the snap-acting means thereof, the connecting portion 62 further opens the check valve 46 of the quick-release valve coupling 40. The connecting portion 62 and fire hose receiving portion 42 are each shaped such that a tapered part of the connecting portion 62 pushes back a flow stopping component of the check valve 46 and thereby mechanically actuates and opens the check valve 46. The skilled person will appreciate that the actuation of the check valve 46 by the connecting portion 62 of the fire hose 60 may be provided in any known way.

As shown in FIG. 1, the fire hose 60 comprises the connecting portion 62 at one end thereof and an interconnecting portion 64 at a second end thereof. The interconnecting portion 64 comprises a quick-release valve coupling similar to the quick-release valve coupling 40 of the dry-riser, configured to receive a connecting portion 62 of another fire hose 60 as well as to receive a firefighting tool, such as a jet pipe or a nozzle, with a connecting portion similar to that of the fire hose 60. The interconnecting portion 64 similarly provides a fluid connection between elements received at the interconnecting portion 64 and the aperture of the fire hose 60. Thereby, the fire hose 60 can either be connected to a nozzle for use in firefighting or be extended in length in a quick and seamless manner. In other examples, a second fire hose and/or a fire-fighting tool may be non-removably attached to the interconnecting portion 64.

A respective fire hose 60 is, as shown in FIG. 1, provided on a respective storey 100, 200, 300 of the building 2. Alternatively, a fire hose 60 may be brought from a fire truck to the relevant storey 100, 200, 300 by a firefighter. The fire hose 60 has an inner diameter of the aperture of 30 mm and are made in a rubber material to withstand an operating water pressure of 50 bar. Due to gravitational force acting on the water and the pressure reduction by letting out water during firefighting the actual water pressure in the fire hose 60 may be lower than the 50 bar operating water pressure. In some diameter of the supply hoses may be less than 30 mm, such as approximately 28 mm, 26 mm, 25 mm, 23 mm, 20 mm, or less, or between than 30 mm and 40 mm, such as 32 mm, 34 mm, 35 mm, 38 mm, or up to 40 mm.

The two inlets 30, 32 of the dry-riser 10 are arranged below the outlets 20, 22, 24 in the vertical height direction H. As seen from FIG. 1, the inlets 30, 32 are arranged outside the building 2. In practice, the inlets 30, 32 may preferably be arranged so that fire trucks can get easy access thereto, such as on an outer wall of the building 2 approximately one metre above ground level. Alternatively, or additionally the inlets 30, 32 may be arranged at a basement level, such as in or by an underground parking facility, and/or may be arranged free-standing at a distance from the building 2, i.e. not attached to the outer wall of the building 2. In other examples of the dry-riser more than two, such as three, four, five, six, or more inlets 30, 32 may be provided or alternatively a single inlet may be provided.

The two inlets 30, 32 comprise identical features in terms of a quick-release valve coupling 50 comprising a supply hose receiving portion 52 for receiving and retaining a supply hose 70 as indicated in FIG. 2. The supply hoses 70 are rubber hoses similar to the fire hoses 60. In other examples, the supply hoses may be different from the fire hoses 60 in one or more of dimensions, material, and/or shape. The supply hoses 70 thereby have an inner aperture with a diameter of approximately 30 mm or 30 mm. In other examples, the diameter of the supply hoses may be less than 30 mm, such as approximately 28 mm, 26 mm, 25 mm, 23 mm, 20 mm, or less, or more than 30 mm, such as 32 mm, 34 mm, 35 mm, 38 mm, or more. The supply hoses 70 may be configured, preferably by means of materials and dimensions, to have an operating pressure similar to that of the dry-riser 10, such as 50 bar.

The supply hose receiving portion 52 comprises a check valve 56 and is configured to receive and retain the supply hose 70 in a manner similar to the way, in which the fire hose receiving portion 42 of the outlets are configured to receive and retain a fire hose 60, i.e. by means of spring-loaded snap-acting means configured to engage and retain the supply hose 70. This will be described further with respect to the examples of the dry-riser system 1′ shown in FIGS. 3-5b below. It will, however, be self-evident that the connection between the supply hose 70 and a quick-release valve coupling 50 of a respective inlet 30, 32 in the examples of FIGS. 1 and 2 may be provided in a similar manner as in the examples shown in FIGS. 3-5b.

The quick-release valve coupling 50 further comprises a manually operated ball valve 54 arranged downstream of the supply hose receiving portion 52 and check valve 56. The manually operated ball valve 54 is similar to the manually operated ball valve of the quick-release valve couplings 40 of the outlets 20, 22, 24. In other examples, the manually operated ball valve 54 of an inlet 30, 32 may be different from that of the outlets 20, 22, 24. The manually operated ball valve 54 may be any known manually operated ball valve able to operate at the desired operating pressure, such as the same operating pressure as for the dry-riser 10. Alternatively or additionally, the manually operated ball valve 54 may be a different type of manually operated valve, such as a manually operated butterfly valve, a manually operated globe valve, a manually operated gate valve, and/or a manually operated diaphragm valve. In some examples, as will be described with reference to FIGS. 3-Sb, the manually operated ball valve 54 may be avoided, such that the check valve 56, with respect to the water flow, may be connected directly to the first section 12 or any potential other portion of the dry-riser 10.

The dry-riser 10 further comprises an emptying outlet 80 for emptying water from the dry-riser first section 12 after use, e.g. when a fire has been extinguished in the building 2. The emptying outlet 80 comprises a manually operated valve for opening the emptying outlet 80 so as to let out water from the dry-riser 10 there through. The manually operated valve of the emptying outlet 80 is similar to the manually operated ball valve 54 of the quick-release valve coupling 50 of the inlets 30, 32 as well as the manually operated ball valve 44 of the quick-release valve coupling 40 of the outlets 20, 22, 24. In other examples, the manually operated valve of the emptying outlet 80 may be of another type, such as the possible types mentioned with respect to the inlet and/or outlet manually operated ball valves 44, 54.

The emptying outlet 80 is arranged at a lowermost point of the dry-riser first section 12 so as to allow gravitational force acting on the water in the dry-riser first section 12 to aid in emptying the dry-riser 10, when the emptying outlet is opened. In other examples, the emptying outlet 80 may be arranged at another position at the dry-riser 10 and may comprise other means, such as pumps, air inlets, or the like to aid in emptying the dry-riser 10.

As shown in FIGS. 3-5b, the emptying outlet 80 is arranged neighbouring the inlets 30′, 32′ and further comprises a traditional Storz coupling TS. The traditional Storz coupling TS comprises a manually operated ball valve and may be used to connect a traditional supply hose of dimensions corresponding to a traditional fire hose, where supply hoses 70, 72 cannot be provided. In other examples of the dry-riser 10′, the traditional Storz coupling TS as well as the manually operated ball valve may be avoided.

As seen in FIG. 1, the dry-riser 10 further comprises an air inlet 90 for letting in air, i.e. pressurised air, into the dry-riser 10 to aid in emptying the dry-riser, when the emptying outlet 80 is opened. The air inlet 90 comprises a manually operated valve arrangement in the form of a ball valve for letting through air when opened and for closing off for water inside the dry-riser 10 when closed, such that an operating water pressure as described above can be maintained in the dry-riser first section 12. In other examples, the manually operated valve arrangement may be another type of valve arrangement, such as a check valve, gate valve, piston valve, or any of the manually operated valves described with respect to the manually operated ball valves 44, 54 of the out-/inlets 20, 22, 24, 30, 32.

The valve arrangement of the air inlet 90 may in some examples comprise an overpressure valve arrangement configured to let out air from the dry-riser 10, when an air pressure inside the dry-riser 10 exceeds a threshold pressure. Thereby, water inside the dry-riser may push out the air through the overpressure valve arrangement of the air inlet 90, when this is provided, aiding in ensuring a sufficiently high water pressure at a, in a vertical height direction H, high point of the dry-riser, such as at the outlet 24 as shown in FIG. 1.

FIGS. 3, 4, 5a, and 5b show a different embodiment of a dry-riser system 1′. The dry-riser system 1′ here comprises a dry-riser 10′ having a first section 12 and a second section 14, which is angled 90 degrees with respect to the first section 12. The first 12 and second 14 sections have the same outer and inner diameter, are made from the same material, and are interconnected by a pipe fitting 16, in turn providing a fluid connection between the first 12 and second 14 sections. In other examples, the first 12 and second sections 14 are angled with another angle, e.g. less than or more than 90 degrees with respect to each other. Alternatively or additionally, the first 12 and second sections 14 may have different dimensions and/or be made from different materials.

It will further be appreciated that the dry-riser 10, 10′ may comprise any number of sections 12, 14 extending in the height direction H and/or at any angle thereto. For instance, where dry-riser system 1, 1′ is used in an engineering structure different from the building 2, such as a ship or a vessel, dry-riser sections 12, 14 may mainly extend in a substantially horizontal direction. Such sections may be interconnected by means of a number of pipe fittings 16 or by means of various flexible interconnectors, for which an operating pressure similar to the desired operating pressure of the dry-riser 1, 1′ can be achieved.

The dry-riser 10′ further comprises two outlets 20, 26 arranged at a same level in the vertical height direction H. The outlets 20, 26 each comprise a quick-release valve coupling 40 having a manually operated ball valve 44 and a fire hose receiving portion 42 as described with respect to the dry-riser 10 of FIGS. 1 and 2. Similarly, the fire hose receiving portion 42 of the quick-release valve coupling 40 comprise a check valve (not shown in FIGS. 3-5). As seen in FIG. 4, showing the outlet 26, to which a fire hose 60 is connected by the connecting portion 62 of the fire hose 60, the manually operated ball valve comprises a handle 44a, which a user, such as a firefighter, can use to open and/or close the manually operated ball valve 44.

Furthermore, the dry-riser 10′ comprises two inlets 30′, 32′ connected to and arranged at the second section 14. The inlets 30′, 32′ extend in a substantially horizontal direction, i.e. in a direction substantially perpendicular to the height direction H. The inlets 30′, 32′ each comprise a quick-release valve coupling 50′ having a supply hose receiving portion 52, similar to that of the quick-release valve couplings 50 of the inlets 30, 32 described with reference to FIGS. 1 and 2. The quick-release valve coupling 50′ does, contrary to the quick-release valve coupling 50, not comprise a manually operated valve. A check valve of the supply hose receiving portion 52 is therefore in direct fluid connection with the inlet 30′, 32′. Other features of the inlets 30′, 32′ as well as their respective quick-release valve coupling 50′ are, however, similar to those of the inlets 30, 32 and their respective quick-release valve coupling 50, described with reference to FIGS. 1 and 2. Notably, the supply hose receiving portion 52 of the quick-release valve coupling 50′ and the features and functionality thereof are similar to those of the supply hose receiving portion 52 of the quick-release valve coupling 50.

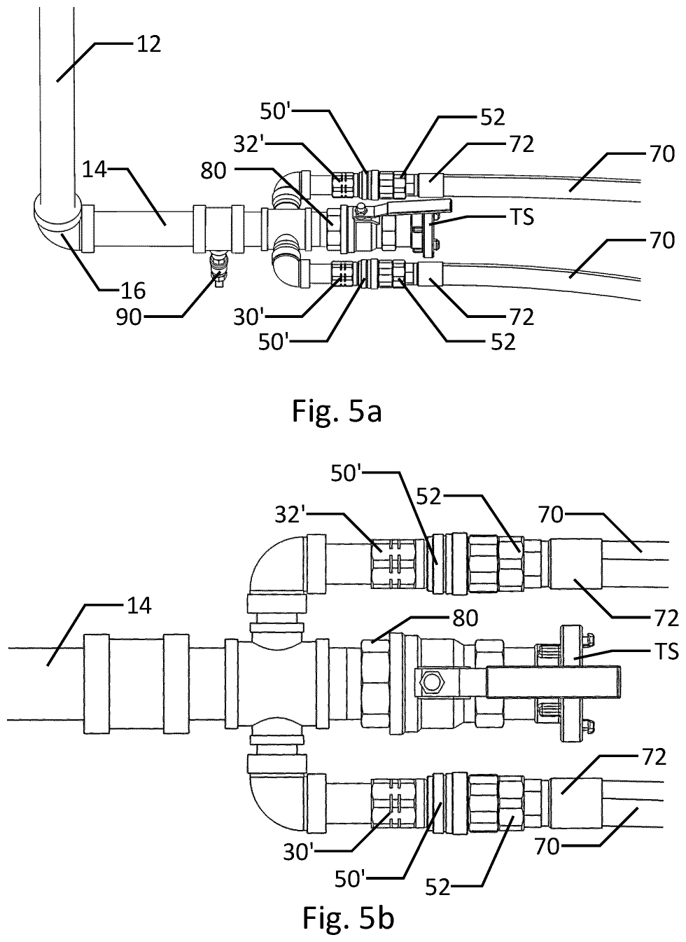

As shown in FIG. 5a, showing a perspective zoomed view of the inlets 30′, 32′, and FIG. 5b, showing a top view of the inlets 30′, 32′, a respective supply hose 70 is connected to a respective one of the inlets 30′, 32′ by connecting the connecting portion 72 of each supply hose 70 to a respective supply hose receiving portion 52 of a respective quick-release valve coupling 30′, 32′. The connecting portion 72 of the supply hose 70 opens the check valve (not shown in FIGS. 3-5b) of the supply hose receiving portions so as to provide a fluid connection, allowing for a water flow, from an aperture of the supply hose 70 to a respective inlet 30′, 32′. The supply hose receiving portions 52 engages with and retains the supply hose 70 by a spring-loaded mechanism engaging with the connecting portion 72 of the supply hose 70. This is done in a similar manner as described above with reference to the fire hose connecting portions 62 and fire hose receiving portions 42. The supply hose receiving portions 52 may, in other examples engage with and/or retain the supply hose connecting portion 72 in a different way.

Although some examples have been described and shown in detail, the present disclosure is not restricted to these, but may also be embodied in other ways within the scope of the subject matter defined in the following claims. In particular, it is to be understood that other examples may be utilised and that structural as well as functional modifications may be made without departing from the scope of the present disclosure. It should furthermore be emphasised that the term “comprises”/“comprising” when used in this specification is taken to specify the presence of stated features, integers, steps, or components but not preclude the presence or addition of one or more features, integers, steps, components, or groups thereof.

What is claimed is:

1-13. (canceled)

14. A dry-riser for use in firefighting, the dry-riser being configured to allow a fluid flow through the dry-riser, comprising:
at least one dry-riser inlet; and
at least one dry-riser outlet;
wherein the at least one dry-riser outlet comprises a quick-release valve coupling configured to connect the at least one dry-riser outlet to a fire hose.

15. The dry-riser according to claim 14, wherein the at least one dry-riser inlet comprises a second quick-release valve coupling configured to connect the dry-riser inlet to a water supply.

16. The dry-riser according to claim 14, wherein the second quick-release valve coupling comprises a check valve.

17. The dry-riser according to claim 16, wherein the check valve is arranged upstream of a manually operated valve of the second quick-release valve coupling.

18. The dry-riser according to claim 14, wherein the quick-release valve coupling comprises a check valve.

19. The dry-riser according to claim 18, wherein the quick-release valve coupling further comprises a manually operated valve.

20. The dry-riser according to claim 19, wherein the manually operated valve is a ball valve.

21. The dry-riser according to claim 19, wherein the check valve of the quick-release valve coupling is arranged downstream of the manually operated valve.

22. The dry-riser according to claim 14, wherein the fluid is water, and wherein at least a portion of the dry-riser is configured to have a high pressure operating water pressure of at least 20 bar.

23. The dry-riser according to claim 22, wherein the at least a portion of the dry-riser is configured to have a high pressure operating water pressure in a range of 20 bar-150 bar.

24. The dry-riser according to claim 23, wherein the at least a portion of the dry-riser is configured to have a high pressure operating water pressure in a range of 30 bar-80 bar.

25. The dry-riser according to claim 14, wherein an inner diameter of at least a portion of the dry-riser is less than 2.0 inches.

26. The dry-riser according to claim 25, wherein an inner diameter of at least a portion of the dry-riser is less than 1.4 inches.

27. The dry-riser according to claim 25, wherein an inner diameter of an outlet of the dry-riser is less than 2.0 inches.

28. A dry-riser system for use in firefighting, the system comprising:
at least one fire hose; and
a dry-riser configured to allow a fluid flow through the dry-riser, the dry-riser comprising at least one dry-riser inlet and at least one dry-riser outlet;
wherein the at least one dry-riser outlet comprises a quick-release valve coupling configured to connect the at least one dry-riser outlet to the at least one fire hose.

29. The dry-riser system according to claim 28, wherein the at least one fire hose comprises a quick-release coupling part configured to be connected to the quick-release valve coupling so as to, in a connected state, allow a water flow from the dry-riser to the at least one fire hose.

30. The dry-riser system according to claim 28, wherein the at least one fire hose is dimensionally stable.

31. The dry-riser system according any one of claim 28, wherein an inner diameter of the at least one fire hose is less than 1.6 inches.

32. The dry-riser system according to claim 28, wherein an inner diameter of the at least one fire hose is less than or equal to 1.2 inches.

33. A dry-riser system, for use in firefighting, the dry-riser system comprising:
an engineering structure comprising a dry-riser configured to allow a fluid flow through the dry-riser, the dry-riser comprising at least one dry-riser inlet and at least one dry-riser outlet;
wherein the at least one dry-riser outlet comprises a quick-release valve coupling configured to connect the at least one dry-riser outlet to the at least one fire hose.
